(19) United States
(12) Patent Application Publication
(10) Pub. No.: US 2009/0012850 A1
(43) Pub. Date: Jan. 8, 2009

(54) METHOD AND SYSTEM FOR PROVIDING A TRUE PERFORMANCE INDICATOR

(75) Inventors: Leslie Stretch, Danville, CA (US); Ravindar R. Roopreddy, Fremont, CA (US)

Correspondence Address: STRATEGIC PATENT GROUP, P.C., P.O. BOX 1329, MOUNTAIN VIEW, CA, 94042, US

(73) Assignee: Callidus Software, Inc., San Jose, CA (US)

(21) Appl. No.: 12/164,548

(22) Filed: Jun. 30, 2008

Related U.S. Application Data
(60) Provisional application No. 60/947,614, filed on Jul. 2, 2007.

(51) Int. Cl. G06Q 10/00

(52) U.S. Cl. 705/11

(57) ABSTRACT

A method, system, and executable software product evaluate the performance of an individual. The method and system include receiving employment information for the individual. The employment information includes information from at least one employer of the individual. The method and system also include storing the employment information and providing to an employer access to the employment information for predicting a performance of the individual. The employer is different from at least a portion of the employer(s) of the individual.

### CROSS-REFERENCE TO RELATED APPLICATIONS

This application claims the benefit of provisional Patent Application Ser. No. 60/947,614, filed Jul. 2, 2007, assigned to the assignee of the present application, and both incorporated herein by reference.

### BACKGROUND OF THE INVENTION

One business problem today is a lack of tools and techniques to effectively measure and represent the current and past performance of potential and actual employees in a uniform way. As used herein, an employee could also include a contractor, a consultant, or other individual engaged to perform work for the employer. This inability to accurately measure relevant characteristics of a prospective/actual employee makes it more difficult to predict the individual's suitability for a particular position. Currently, predictions related to the success of an individual commence with obtaining information on that individual. To this end, an employment history is typically recreated for a prospective employee in the context of employee recruiting events. For example, the information on a particular individual is received from the individual in response to specific questions, potentially via a written job application and/or interview as well as in a resume. For an individual that is already an employee, the individual's employment record with the company may also be available. Using this information, the employer makes decisions related to hiring, promotions, and other issues.

Although this mechanism is widely used, there are drawbacks. This type of information gathering is laborious and the metrics are not uniform. The prediction may be inaccurate in part because there is limited visibility into the individual's past performance. In reality, the prediction of performance typically only improves as the candidate builds a history at a given company through evaluation of the skills and achievements.

### BRIEF SUMMARY OF THE INVENTION

A method, system, and executable software product for evaluating the performance of an individual are described. The method and system include receiving employment information for the individual. The employment information includes information from at least one employer of the individual. The method and system also include storing the employment information and providing to an employer access to the employment information for predicting a performance of the individual. The employer is different from at least a portion of the employer(s) providing employment information. In one aspect, providing access to the employment information includes calculation of a performance indicator based on the employment information. The calculation may utilize categories, key indicators, and/or weights selected by the employer. In another aspect, the method and system include the employer receiving a template for determining a performance indicator for the individual in a profession. The template includes a plurality of categories and at least one key indicator corresponding to the plurality of categories. In this aspect, the method and system also include customizing the template including selecting at least one of a portion categories, a portion of the key indicator(s), and weight(s). The method and system in this aspect also calculate the performance indicator using the template, the customization information, and employment information for the individual.

According to the method and system disclosed herein, tools for predicting the performance of an individual may make use of more information, might be customized to a particular employer and/or position within an employer, may provide a normalized performance indicator, and may thus provide a better mechanism for predicting the performance ability of individuals.

### BRIEF DESCRIPTION OF SEVERAL VIEWS OF THE DRAWINGS

FIG. 1 depicts an exemplary embodiment of a method for evaluating individuals.

FIG. 2 depicts an exemplary embodiment of a system for evaluating individuals.

FIG. 3 depicts another exemplary embodiment of a method for evaluating individuals.

FIG. 4 depicts another exemplary embodiment of a method for evaluating individuals.

FIG. 5 depicts another exemplary embodiment of a method for evaluating individuals.

### DETAILED DESCRIPTION OF THE INVENTION

The following description is presented to enable one of ordinary skill in the art to make and use the invention and is provided in the context of a patent application and its requirements. Various modifications to the embodiments and the generic principles and features described herein will be readily apparent to those skilled in the art. Thus, the method and system are not intended to be limited to the embodiments shown, but is to be accorded the widest scope consistent with the principles and features described herein.

The method and system are mainly described in terms of particular systems provided in particular implementations. However, one of ordinary skill in the art will readily recognize that this method and system will operate effectively in other implementations. For example, the systems, devices, and networks usable with the present invention can take a number of different forms. The method and system will also be described in the context of particular methods having certain steps. However, the method and system operate effectively for other methods having different and/or additional steps not inconsistent with the method and system.

A method, system, and executable software product evaluate the performance of an individual. The method and system include receiving employment information for the individual. The employment information includes information from at least one employer of the individual. The method and system also include storing the employment information and providing to an employer access to the employment information for predicting a performance of the individual. The employer is different from the employer(s) who provided employment information. In one embodiment, providing access to the employment information includes calculation of a performance indicator based on the employment information. In one embodiment, the calculation utilizes categories, key indicators, and/or weights selected by the employer. In another aspect, the method and system include the employer receiving a template for determining a performance indicator for the individual. The template including a plurality of categories and at least one key indicator corresponding to the plurality of categories. In this aspect, the method and system also include customizing the template including selecting at least one of a portion categories, a portion of the key indicator(s), and weight(s). The method and system in this aspect also calculate the performance indicator using the template, the customization information, and employment information for the individual.

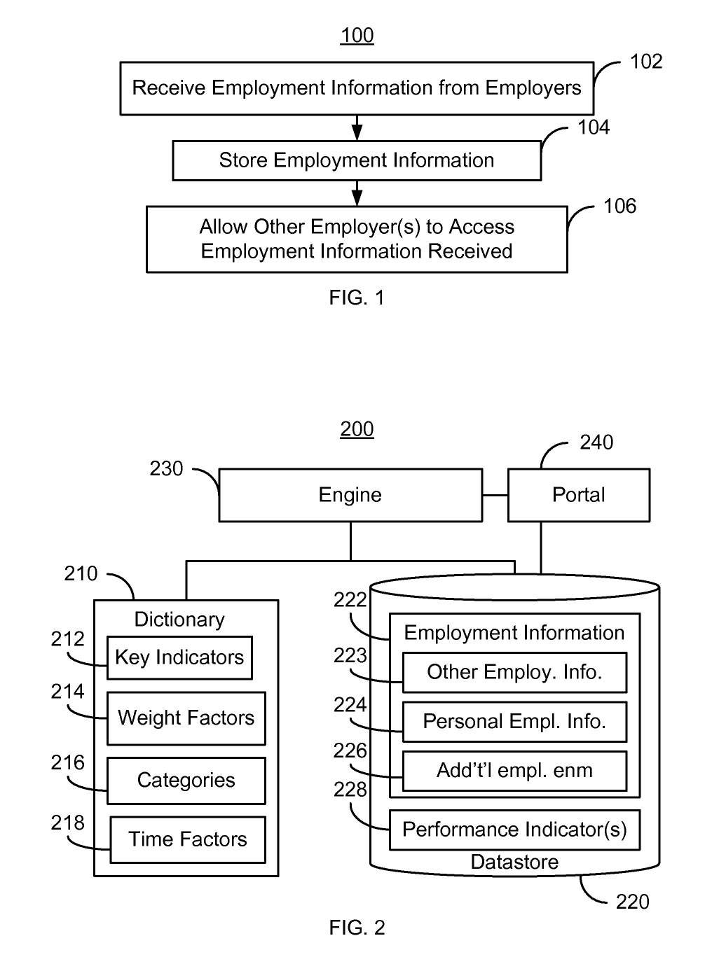

FIG. 1 depicts an exemplary embodiment of a method 100 for evaluating individuals. In one embodiment, the evaluation is used by employers for predicting the performance of the individuals. For example, the method 100 may be used for predicting the performance of candidates for a particular position at an employer. The individuals may or may not be currently employed by the company. For example, the individuals may include sales people, independent sales agents, and/or other types of employees/contractors. In one embodiment, the method provides a performance indicator, also termed a true performance indicator or TPI. The method 100 may be implemented utilizing a computer system (not shown in FIG. 1).

Employment information is received for the individual(s) to be evaluated, via step 102. The employment information for each of the individuals includes information from one or more employers of the individual. Such employers may be current or past employers of the individual. In one embodiment, at least some of this employment information from the employer(s) is private information. Such information might include performance reviews, the position held, quotas the individual was to meet, TPIs the employer has calculated internally, TPIs the individuals have previously had calculated, and other information. As such, the employer(s) of the individual as well as the individual would consent to providing the employment information. For example, when leaving a particular company, the individual may authorize the employer to update his/her employment information. In one embodiment, the employer(s) provide the employment information on their employees in exchange for having access to employment information from other employers.

In addition to information from employers, the employment information provided in step 102 might also include personal employment information provided by the individual. Such information might include information in a resume, such as previous employment and education. The personal employment information may also include the individual's TPI from the employer or which the individual consented being made publicly available.

The employment information is stored, via step 104. In one embodiment, the employment information is stored in a datastore. The employment information may also be categorized in storage. The categories, which may otherwise be termed domains, may be based on the industries of the employers or the employee. Sub-categories, otherwise known as key indicators, may also be used to be used to further categorize the information. In one embodiment, the raw information may be stored. For example, a category might be “sales metrics” or “work history” while the key indicator might be “quotas met”, or “number of employers”. In another embodiment, the employment information may be otherwise processed and stored. For example, a TPI, described below, or other score relating to the individual's performance may be stored for the individual. The datastore may be a community datastore accessible to the employer(s) that agree to provide employment information about their own employees. This agreement may be facilitated by providing the users, employers and individuals, with free services, such as software associated with the method 100. Thus, the datastore may be a central repository for all information received from some set of employers. In another embodiment, the employment information may also be stored in a private datastore, or datamart, for a particular employer wishing to evaluate employees. In such an embodiment, some or all of the community datastore might be replicated to the private datastore accessible only by the owner/employer.

Access to the employment information is provided to an employer for predicting a performance of the individual, via step 106. The employer is different from the at least a portion of the employer(s) that provide employment information. Stated differently, the employer is allowed access to employment information that contains data from other employers. Although the employment information may also contain information from the individual or the employer accessing the information in step 106, at least some of the employment information is directly from another employer.

In one embodiment, the access provided in step 106 includes access to the employment information in the datastore for internal calculation of a TPI, or performance indicator. For example, the employer may have an internal metric in their own computer system that is used to calculate the TPI. In such an embodiment, the employer may import the employment information from community database to their own datamart and optionally utilize internal information if available to calculate the TPI. In addition, the employment information used and the weights accorded to portions of the employment information might be customized to the employer to make the TPI more meaningful. Such a TPI may be considered to be an internal TPI. In another embodiment, step 106 includes calculation of a TPI that is made available to the employers contributing employment information in step 102. Such a TPI may be considered to be a public TPI. A particular individual's TPI may also be portable. As a result, the individual's TPI may be updated throughout their employment history and be made available to employers and/or other entities. Thus, the individual may improve their marketability by providing a TPI that allows prospective employers or others to assess the individual's abilities. The employment information used and the weights accorded to portions of the employment information might be selected by a set of employers in an industry. In embodiments in which a TPI is calculated, the TPI may be expressed as a normalized, numerical score.

Using the method 100, the employer has access to employment information from other employers. Consequently, the employer is not limited to information provided by individuals or which they have collected for their own employees. In addition, the TPIs may be normalized and take desired employment information relevant to a specific industry, employer, and/or position into account. As a result, employers may be better able to compare different individuals. Employers may, therefore, be better able to predict the success of candidates for employment. Further, the method 100 may be used to calculate TPIs using the same metrics for employers across a specific industry. As a result, the ability of employers in the industry to compare individuals may be improved. This is particularly true where the TPI is expressed as a normalized value. Further, the method 100 may be implemented as a software as a service to improve accessibility. Moreover, provision of a TPI and like services could become an industry in and of itself, providing TPIs as employee ratings and allowing employers and/or individuals to solicit services based on their TPI or that of their employees.

Individuals also have an interest in using the TPI. The individuals may present their TPI to prospective employers as part of their performance track record. For example, the individual's TPI may be stored in the community database and be made available via the method 100. The TPI may thus be readily and securely accessible by the individual and those he has given access rights to. The individual's TPI may also be provided to their employers and updated through the method 100 to provide an ongoing record of the individual's performance.

FIG. 2 depicts an exemplary embodiment of a system 200 for evaluating an individual. The system 200 may thus be used in implementing the method 100. In one embodiment, the system 200 is publicly accessible. In another embodiment, the system 200 may be a private system, for example internal to an employer. The system 200 includes a dictionary 210, a datastore 220, an engine 230, and portal 240.

The portal 240 acts as a user interface portal and may include web services APIs to allow employers and individuals access to the system 200. The portal 240, or other portion of the system 200, may also limit access to the system to authorized users. For a public or community system, for example, only employers that agree to provide information on their employees and individuals having TPIs corresponding to the system 200 may be allowed to access the system 200. The same may be true for individuals. This agreement may be facilitated by providing the users, employers and individuals, with free services, such as software, to aid in gathering the employment information 222. For example, a sales performance management solution set or other employment software may be provided to employers. Further, access to a particular individual's employment information, either for viewing or for adding employment information, may be limited to those entities that the individual has authorized. For a private system 200, the portal 240 may allow the user access to a public/community system from which employment information from other employers and/or TPIs are accessed. In such an embodiment, the portal 240 may also allow access by authorized individuals within the employer.

The datastore 220 stores employment information 222 and TPIs/performance indicators 228. The employment information 222 includes employment information from employers 223 and personal employment information 224 from the individuals. Such information might include previous employment, education and/or the individual's TPI from a previous employer. If the system 200 is private, then the employment information 222 may also include the employer's internal, or additional, employment information 226. Such internal employment information may include performance reviews, quotas, or TPIs the individual has had while at the employer. The internal employment information may thus be the same as would be provided by another employer. In a private system, then at least the information 223 and 224 may be imported from a public/community system. In such an embodiment, the datastore 220 may be used to temporarily store at least some of the employment information 222, rather than archiving all of the employment information 222. If the system is public, then a particular employer's information 226 may be part of the employment information 223. The datastore 220 also includes performance indicator(s) 228, or TPIs, that have already been calculated. For a public/community system 200, the TPIs 228 are calculated and available to the employers contributing information to the datastore 220. Such TPIs 228 may be considered the portable TPIs of particular individuals. For a private system, the TPIs 228 may include internal TPIs specifically for the employer as well as public TPIs that the employer has received from a public/community system. The values for the employment information 222 may come from sources (not shown) external to the system 200 that may be internal and/or external to an organization. Such source may include but are not limited to, human resources of an employer, payroll an employer, evaluations done by an employer, background check systems.

The dictionary 210 includes data structures used in calculating the TPIs 228. Although depicted as a dictionary 210, the data structures may be stored in another manner. Further, the data in the dictionary 210 may be stored in the datastore 220. The datastore includes key indicators 212, weights 214, categories 216, and time factors 218 that are used in determining the TPIs. Categories 216 are those into which the contributing factors are classified. The categories 216, also known as domains, may include information that contributes a specific amount to the TPI. Stated differently, a key category 216 has a maximum contribution value percentage towards TPI score. The categories 216 may be specific to an employer or an industry. Key indicators 212 are sub-categories of the categories 216 in the form of numeric or enumerated values. In one embodiment, each key indicator 212 has a specific maximum contribution to the category 216. For key indicators 212 that are enumerated values, a mapping table or similar mechanism converts the enumerated value to numeric value.

Thus, a particular score for a key indicator 212 has a value that is mapped to the corresponding category 216. Weights 214 indicate the how heavily a particular category 216 and/or key indicator 212 is weighted in calculation of the TPI. The time factors 218 correspond to the time that employment information 222 is provided and may be used to age the employment information 222. Stated differently, the time factors 218 may be used to account for the age of the employment information 222. Thus, the time factors 218 may be used to decay employment information 222 over time. As a result, newer employment information 222 may be accorded a higher weight than older employment information. In one embodiment, this is accomplished by reducing the weight 214 for older employment information 222. Table 1 depicts an exemplary embodiment of some categories 216, key indicators 212, weights 214, and time factors that might be stored in the dictionary 210.

TABLE 1

| CATEGORY OR KEY INDICATOR | DIGEST VALUE | SCORE |
|---|---|---|
| Category-Work History | 25% | |
| Key Indicator-No, of Employers | 5 | 5 |
| Key Indicator-Past Appraisals | 3.8 | 160 |
| Category-Endorsements | 5% | |
| Key Indicator-Employer References | 3 | 6 |
| Key Indicator-Customer References | 7 | 14 |
| Key Indicator-Professional Endorsements | 4 | 8 |
| Category-Leadership Skills | 5% | |
| Key Indicator-Number of Subordinates | 35 | 15 |
| Key Indicator-Position Level | Director | 15 |
| Category-Work Experience | 10% | |
| Key Indicator-Years in Profession (Sales) | 16 | 32 |
| Key Indicator-Experience Relevance | 70% | 35 |
| Category-Educational Qualifications | 15% | |
| Key Indicator-Degree Earned | Bachelors | 80 |
| Category-Continuing Education | 5% | |
| Key Indicator-Days Training | 40 | 5 |
| Key Indicator-Course Titles | SPIN, SS, | 5 |
| | TEC, TAS | |
| Key Indicator-Current Techniques Used | TAS | 10 |
| Key Indicator-Latest Training Taken | MH | 3 |
| Category-Profession Metrics (Sales) | 25% | |
| Key Indicator-Quota Range | $1M-$4M | 80 |
| Key Indicator-Products | Yes | 20 |
| Key Indicator-Services | Yes | 20 |
| Key Indicator-Actual Versus Forecast | 70% | 50 |
| Key Indicator-Number of Deals | 11 | 11 |
| Key Indicator-Deal Size Range | $250K-$20M | 20 |
| Key Indicator-Average Deal Cycle | 9 Months | 10 |
| Category-Recent Appraisals | 10% | |
| Key Indicator-Recent Appraisal | 4.5 | 80 |
| Performance Indicator (TPI) | 1000 | 684 |

The engine 230 utilizes the datastore 220 as well as the dictionary 210 to calculate TPIs. In particular, employment data 222 as well as one or more of the data structures 212, 214, 216, and 218 in the dictionary 210 are used. In one embodiment, existing TPIs 228 may also be used as key indicators in calculation of new TPIs. In a private system 200, information from other employers 223 and personal information 224 may be obtained via the portal 240 from a public/community system and store temporarily in the datastore 220. The engine 230 calculates TPIs using a metric, or digest algorithm that may be customizable. The digest algorithm is a combination of rule formulas that generate at least one digest value for each key indicator 212 in a given domain category 216. The digest values of the key indicators 212 are combined to provide corresponding values for the categories 216. The digest values and corresponding values for the categories 216 are shown in FIG. 2. The engine 230 uses values from the categories 216 and, in some embodiments, factors 214 and 216 to determine an overall digest value, or TPI 228. The TPIs may then be stored in the datastore 220. The TPIs 228 calculated by the engine 230 may then be accessible through the portal 240. For a public/community system 200, the portal 240 may provide access to the TPIs 228 for multiple employers and individuals. However, for a private system 200, only authorized users within the employer and, in some cases, the individual are generally granted access to the TPI 228.

Using the system 200, the method 100 may be implemented and at least some of the benefits thereof achieved. Consequently, evaluation of individuals may be improved.

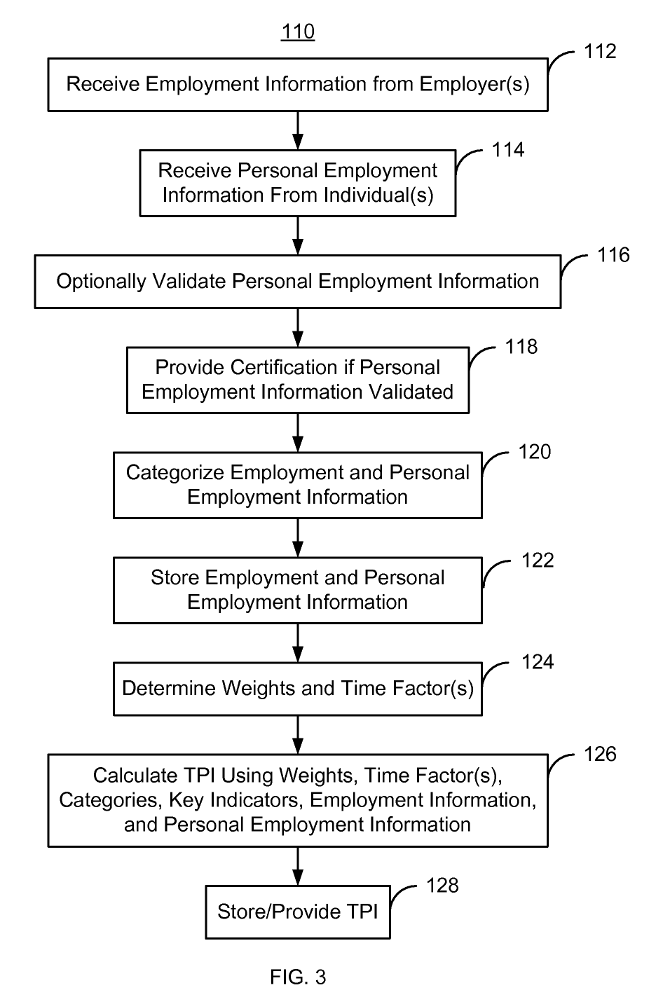

FIG. 3 depicts another exemplary embodiment of a method 110 for evaluating an individual. In one embodiment, the evaluation is used by employers for predicting the performance of the individuals. For example, the method 110 may be used for predicting the performance of candidates for a particular position at an employer. The individual may or may not be employed by the company. In one embodiment, the method provides a performance indicator, or TPI. The method 110 is described in the context of the system 200.

Referring to FIGS. 2-3, employment information 223 and 226 for the individual is received by the system 200 from employers, via step 112. The employment information received in step 112 may thus include information that is private to the individuals and/or employers, such as the individual's personnel information. The employment information received in step 112 may also include information from an employer desiring to evaluate the individual. Step 112 may be received via a portal 240 or other input/output I/O device such as a keyboard (not shown in FIG. 2). Personal employment information, described above, for the individual is also received, via step 114. In one embodiment, the personal information may be provided directly to the system 200 by the individual, via the portal 240. Alternatively, personal employment information may be input in another manner. For example, information in the individual's resume may be input by an employee of the employer.

The personal employment information may optionally be validated, via step 116. Validation checks the personal employment information for correctness. Thus, validation in step 116 may include live interviews with the individual, references, and/or other relevant persons. If the personal employment information is validated, then the personal employment information may be certified, via step 118. Certified personal employment information is considered to be better information and, therefore, may result in a higher evaluation. Alternatively, certification in step 118 could be provided for the TPI calculated. In such an embodiment, step 118 may be performed after or as part of step 126.

The employment information is categorized based on particular categories 216, or domains, and key indicators 212, via step 120. As discussed above, domains correspond to categories that may be of interest to the industry, a particular profession, and/or employer(s), while key indicators correspond to sub-categories. Key indicators have a specific contribution to a calculation of a TPI. The employment information 222, including information 223, 224, and 226 is stored, via step 122. In one embodiment, the employment information is stored based on the categories 216 and/or key indicators 212. For example, metadata may be stored with the employment information 222 that associates portions of the employment information 222 with the appropriate categories 216 and key indicators 212, as well as weights 214 and time factors 218. In another embodiment, the data structures 212 and 216 may include data that associates these structures 212 and 216 with the appropriate portions of employment information 222.

The weights 214 and time factors 218 are determined, via step 124. Although depicted as separate from step 126, step 124 may be included in the calculation performed for step 126. Step 124 may include determining a time interval between the current time and the times particular pieces of employment information 222 were provided. Thus, the ages of portions of the employment information 222 may be determined and time factors 218 determined based on the age. These time factors 218 may be used to adjust the weights 214 or otherwise account for the ages of portions of the employment information 222. In particular, the weights 214 of older portions of the employment information 222 may be reduced, or decayed, to limit the effect that stale employment information 222 has on the evaluation of the individual.

The TPI is calculated, via step 126. In one embodiment, the TPI is normalized to a particular maximum number, such as 1000 points. Such an embodiment may be completed as follows.

Each key category 212 and key indicator 216 in a category has a maximum possible contribution value. The current contribution value is determined by the employment information 222. The maximum contribution values may be specified, for example by the employer. This embodiment may be general purpose across different professions and can support any number of key categories (1 to n) and key indicators (1 to m) in a category. A digest algorithm that calculates the TPI sets the TPI maximum score to be TPIMax=1000 points. The score may be determined as follows.

a. The maximum score for a particular category 216 is calculated as follows.
i. The maximum value for a particular category, n, is Key category ‘n’ maximum value=KCnMaxValue.
ii. The maximum value of all categories 222 is KCAllMaxValue=sum(KC1 MaxValue+ . . . +KCnMaxValue).
iii. Key category ‘n’ maximum score=KCnMaxScore=(KCnMaxValue/KCAllMaxValue)*TPIMax.

b. The maximum score that is possible for each key indicator 212 in a given category ‘n’ is calculated as:
i. Key indicator ‘m’ maximum value=KInMaxValue.
   1. The actual employment information 222 may then be mapped to numerical values to be used by the digest algorithm for example using a mapping table.
ii. The maximum value of all key indicators is KIAllMaxValue=sum(KI1MaxValue+ . . . +KImMaxValue).
iii. The maximum score for another of the categories 222, ‘m’, the maximum score is KImMaxScore=(KImMaxValue/KIAllMaxValue)*KCnMaxScore.

c. The score for a particular key indicator from a particular current contribution value is given by:
i. Key indicator ‘m’ score=KImScore=(KimValue/KImMaxValue)*KimMaxScore.

d. The TPI is then determined by summing the scores for each category. In other words, the TPI=sum(KI1Score+ . . . +KimScore).

Furthermore, certain key indicator values may be emphasized for freshness or decayed because they are aged. Thus newer values for the employment information 222 contribute more while the older values contribute less. This may be achieved through the time factors 218. Overall the calculations may be controlled as follows. The key indicator score=overall factor*key indicator value. The overall factor is defined as: overall factor=weight*time factor. Thus, both the weights 214 and the time factors may be used to appropriately weight each key indicator 212 and account for aging of employment information 222. For example:
a. Presume that the maximum possible value of a particular key indicator 212 is 5 and the weight is 1.0 for simplicity.
b. Suppose that the previous year's value is of that key indicator is 4.5.
c. In addition, suppose
   i. the time factor 218 for this particular key indicator 212 is 0.5. In other words, older information is decayed by fifty percent.
   ii. The score for the previous year would be 4.5*1.0*0.5=2.25.
d. Assume that the current year's value for the same key indicator 212 is 4.0.
   i. Time value factor for this year's value is 1.0 because the information is current.
   ii. The score for the current year is 4.0*1.0*1.0=4.
e. The total score for the key indicator would be 2.25+4.0=6.25. This may be normalized to a maximum possible 7.5 (5*1*0.5+5*1*1) for the two years.

Thus, the algorithm described above may take into account aging of employment information as well as the desired weights for the information. Although the method 110 is described in the context of a particular algorithm, another algorithm that is also general in nature or which has been customized might be used in step 126.

The calculation performed in step 126 takes into account the employment information 222, particular information 222, 224, and if available 226. In addition, the categories 216 and key indicators 214 that happen to be of interest for a particular TPI are used in step 126. Further, the categories 216 and key indicators 212 may be emphasized/deemphasized by the weights 214. In addition, aging of the employment information 222 may be accounted for by using any time factors 218 to decay the weights 214 in step 126. The specific categories 216, key indicators 212, weights 214 and time factors 218 as well as the employment information 222 used may be tailored for the particular TPI being calculated in step 126. For example, the categories 216, key indicators 212, weights 214, time factors 218, and employment information 222 used may be selected by a particular employer, set of employers, individual, or other entity. Thus, step 126 may be customized for a particular individual, a particular employer, a particular position, a particular industry, or other group. Alternatively, the specific categories 216, key indicators 212, weights 214 and time factors 218 as well as the employment information 222 selected used in step 126 may be more general to provide an all-purpose TPI. Further, the validation performed in step 118 may be utilized in step 126 to provide a certified TPI. For example, step 126 may increase the value of a TPI to provide a more positive evaluation if the personal information 224 used in step 126 has been validated. Further, the TPI returned in step 126 may be a normalized score, as is indicated in Table 1. The TPI 218 may then be stored in the datastore 220 or provided via the portal 240 for use and/or storage elsewhere, via step 128.

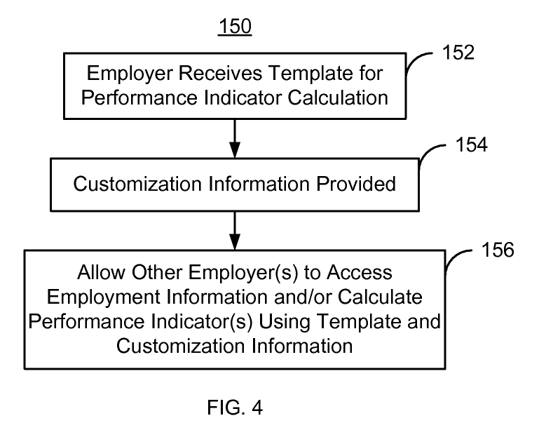

FIG. 4 depicts another exemplary embodiment of a method 150 for evaluating an individual. In one embodiment, the evaluation is used by employers for predicting the performance of the individuals. For example, the method 150 may be used for predicting the performance of candidates for a particular position at an employer. The individual may or may not be employed by the company. In one embodiment, the method provides a performance indicator, or TPI. More specifically, the method 150 may be used by an employer or other analogous entity to customize use of the employment information available via the method 100/110 and system 200. The method 150 is described in the context of the system 200.

A template for determining the TPI based on the employment information 222 is provided to an employer, via step 152. The template includes a number of categories 216 and indicators 212 from which the employer can select. Stated differently, a template includes standard categories of key indicators for a given profession. An employer starts with such a standard template that may be received from shared the repository. The template may further include a digest algorithm which may be used to actually calculate the TPI.

Customization information is provided by the employer, via step 154. Stated differently, the template is customized by/on behalf of the employer in step 154. The customization information includes a selection of at least some of the categories 216 and/or key indicators 212 that are of interest to the employer. In one embodiment, the employer may also be allowed to input additional categories. In addition to selection of a subset of the categories provided in the template, an employer may customize the template with additional categories 216 of key 212 indicators relevant to the company. Further, the customization information provided in step 154 may include weight(s) 214 and an indication of whether and, in some embodiments, how time factors 218 are to be used in calculating the TPI.

The employer may be allowed to access the employment information 222 for determination of the performance indicator using the template and the customization information, via step 156. In one embodiment, step 156 may include calculation of the TPI, for example by the engine 230. In step 156, therefore, the employ may deploy the new, customized template for internal TPI calculations. For example, the template and customization information may be used to customize the digest algorithm used by the engine 230 in calculating the TPI. The TPIs calculated in step 156 may be provided to and/or stored by the employer. As part of step 156, end this internal TPI may be shared back to external, community system.

Using the method 150, the employer has access to employment information from other employers and may customize the selection of employment information 222 actually used to evaluate individuals. Consequently, the employer is not limited to information provided by individuals or which they have collected for their own employees. Further, the template and customization information provided in steps 152 and 154 may allow the employer to tailor the calculation of the TPI. For example, the TPIs may be calculated for the employer's industry and/or specific positions. As a result, employers may be better able to compare different individuals and to predict the success of candidates for employment. The method 150 may further allow the employer to calculate TPIs in the same manner as other employers in the industry. As a result, the employer may better compare their own employees to others in the industry. This is particularly true where the TPI is expressed as a normalized value. Consequently, the employers' ability to evaluate and compare individuals may be improved.

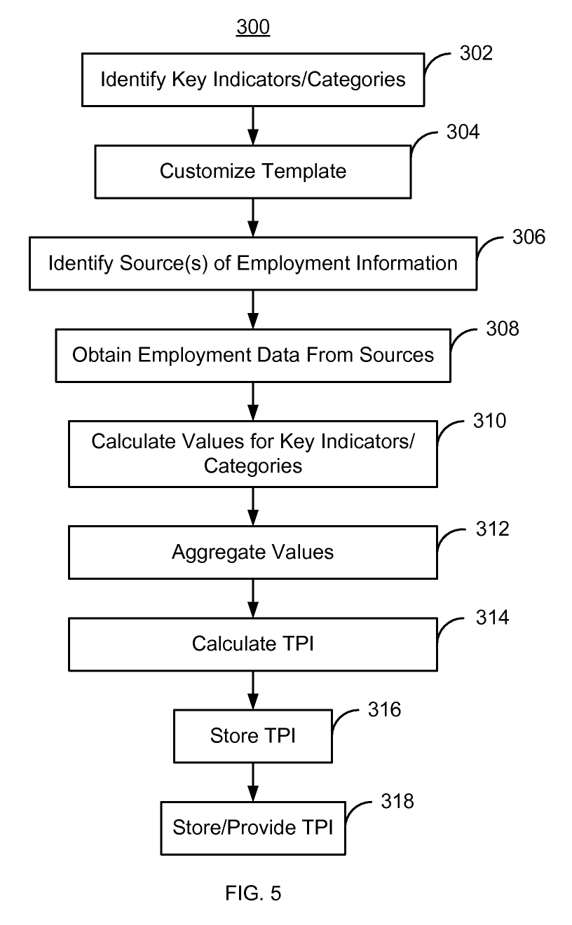

FIG. 5 depicts another exemplary embodiment of a method 300 for evaluating an individual. An administrator or other authorized individual in the employer or who acts on behalf of the employer may start by identifying a set of key indicators 212 and categories 216 for which data may be acquired, via step 302. Each key indicator 212 may also be associated with one or more categories 216. The administrator then creates or fills out a template for measurement, via step 304. This template embodies a set of key indicators 212 and/or categories 216 that are relevant to the profession, industry, or other item for which individuals are desired to be evaluated. Steps 302 and 304 may be considered analogous to steps 152 and 154 of the method 150.

The administrator also identifies the systems that provide the values for the key indicators 212, via step 306. For example, the employer's human resources system, the payroll system, personnel/evaluation system, credential and background check system may provide employment data 222 for individuals. In addition, the public/community system 200 may be identified as a source of employment information, for example from other employers 223 and/or personal employment information 224 from individuals. Step 306 may also include providing a mapping for the employment information 222 obtained to a particular value used in calculating the TPI. Through steps 302, 304, and 306, therefore, the calculation of the TPI may be tailored to a particular employer or other entity.

A background integration processor (not shown in FIG. 5) pulls the relevant values from the sources of employment information 222 into the relevant datastore 220 for the employer, via step 308. In another embodiment, another component may obtain the relevant data and store the data in the datastore 220. In such an embodiment, the datastore 220 may be a temporary, local memory. However, in another embodiment, the data may be archived in the datastore 220.

Once the setup and the input data are ready, the performance engine 230 calculates the values for each key indicator 212 and a category 216 selected, via step 310. In one embodiment, step 310 is performed in real time. Thus, the relevant employment data 222 are obtained in step 310. The data may also be categorized and aggregated, via step 312. The data are then used by the engine 230 to calculate the TPI, via step 314. In one embodiment, the TPI is calculated as described above in step 126. However, in another embodiment, the TPI may be calculated in a different manner. Once calculated, the TPI may be stored, via step 316. Step 316 may include storing the TPI on the employer's own private system or in a public system. The TPI may then be accessed internally or, for example, through the portal 240, via step 318.

Thus, the method 300 allows the employer to have access to employment information from other employers, to customize the employment information 222 actually used to evaluate individuals, sources of employment and to customize the calculation itself. Consequently, evaluation of individuals may be improved.

A method and system for evaluating an individual has been disclosed. The method and system have been described in accordance with the embodiments shown, and one of ordinary skill in the art will readily recognize that there could be variations to the embodiments, and any variations would be within the spirit and scope of the present application. For example, the method and system can be implemented using hardware, software, a computer readable medium containing program instructions, or a combination thereof. Software written according to the present invention may be stored in some form of computer-readable medium, such as memory or CD-ROM, and executed by a processor. Accordingly, many modifications may be made by one of ordinary skill in the art without departing from the spirit and scope of the appended claims.

We claim:

1. A computer-implemented method for evaluating an individual comprising:
receiving employment information for the individual, the employment information including information from at least one employer of the individual;
storing the employment information; and
providing to an employer access to the employment information for predicting a performance of the individual, the employer being different from at least a portion of the at least one employer.

2. The method of claim 1 wherein the access providing further includes:
providing the access to the employment information for determining a performance indicator of the individual.

3. The method of claim 2 wherein the employment information includes personal employment information provided by the individual.

4. The method of claim 3 further comprising:
validating the personal employment information and wherein the access providing further includes
providing a certification for the performance indicator if the personal employment information is validated.

5. The method of claim 2 wherein the employment information storing further includes:
categorizing the employment information based at least one of a plurality of categories and a plurality of key indicators in the plurality of categories; and
storing the employment information based on the at least one of the plurality of categories and the plurality of key indicators.

6. The method of claim 5 wherein the plurality of categories correspond to at least one of an industry and a profession.

7. The method of claim 5 wherein the access providing further includes:
determining the performance indicator based on at least one of a portion of the plurality of categories, a portion of the plurality of key indicators, and a weight for each of the portion of the plurality of categories.

8. The method of claim 7 wherein at least one of the portion of the plurality of key indicators, the portion of the plurality of categories, and the weight are selected by the employer.

9. The method of claim 7 wherein a position and an industry correspond to the employer and wherein the determining further includes:
providing a template to the employer, the template including the portion of the plurality of categories and the weight; and
receiving customization information from the employer, the customization information corresponding to at least one of the position and the industry of the employer.

10. The method of claim 2 wherein the access providing further includes:
calculating the performance indicator as a normalized score.

11. The method of claim 2 wherein employment information has an age, wherein the storing further includes:
determining a time factor for the employment information based on the age; and
wherein the access providing further includes
decaying a weight of the employment based on the time factor.

12. The method of claim 2 further comprising:
receiving from the employer additional employment information related to at least additional one employee of the employer.

13. A computer-implemented method for evaluating an individual comprising:
providing to an employer a template for determining a performance indicator of performance based on employment information for the individual from at least one employer of the individual, the template including a plurality of categories and at least one key indicator corresponding to the plurality of categories, the employer being different from at least a portion of the at least one employer;
receiving customization information from the employer, the customization information including at least one of a portion of the plurality of categories, a portion of the at least one key indicator, and at least one weight, the at least one weight corresponding to the key indicator and the portion of the plurality of categories;
providing to the employer access to the employment information for determination of the performance indicator using the template and the customization information.

14. A computer-implemented method for allowing an employer to evaluate an individual, the method comprising:
receiving a template for determining a performance indicator for the individual, the template including a plurality of categories and at least one key indicator corresponding to the plurality of categories;
customizing the template, the customizing including selection of at least one of a portion of the plurality of categories, a portion of the at least one key indicator, and at least one weight, the at least one weight corresponding to the key indicator and the portion of the plurality of categories;
calculating a performance indicator using the template, the customization information, and employment information for the individual, the employment information from at least one employer of the individual, the employer being different from at least a portion of the at least one employer.

15. A system for evaluating an individual comprising:
at least one datastore for storing employment information for the individual, the employment information including information from at least one employer of the individual; and
a portal, coupled with the datastore, for providing to an employer access to the employment information for determination of a performance indicator for the individual, the employer being different from at least a portion of the at least one employer.

16. The system of claim 15 further comprising:
at least one dictionary, coupled with the at least one datastore, for storing a plurality of data structures corresponding to at least one of a plurality of categories, at least one key indicator for the plurality of categories, timing information for the employment information, and at least one weight.

17. The system of claim 16 further comprising:
at least one engine, coupled with the at least one dictionary and the at least one datastore, for calculating a performance indicator based on the employment information and at least a portion of the plurality of data structures.

18. The system of claim 17 wherein the employment information further includes personal information provided by the individual, wherein the at least one engine further calculates the performance indicator based on a validation of the personal employment information, the performance indicator indicating an improved performance if the personal employment information is validated.

19. The system of claim 18 wherein the at least one engine further determines the performance indicator based on at least one of a portion of the plurality of categories, a portion of the plurality of key indicators, and a weight for each of the portion of the plurality of categories.

20. The system of claim 19 wherein the at least one engine further calculates the performance indicator based on a template provided to and customized by the employer, the template including at least one of the portion of the plurality of categories and the weight; and

21. The system of claim 20 wherein the employment information includes an age and wherein the engine further determines a time factor for the employment information based on the age and decays a weight of the employment based on the time factor.

22. An executable software product stored on a computer-readable medium containing program instructions for evaluating an individual, the program instructions for:
receiving employment information for the individual, the employment information including information from at least one employer of the individual;
storing the employment information; and
providing to an employer access to the employment information for predicting a performance of the individual, the employer being different from at least a portion of the at least one employer.

23. The executable software product of claim 22 wherein the access providing instructions further includes instructions for:
providing the access to the employment information for determining a performance indicator of the individual.

24. The executable software product of claim 23 wherein the employment information includes personal employment information provided by the individual.

25. The executable software product of claim 24 wherein the program further includes instructions for:
validating the personal employment information and wherein the access providing instructions further includes instructions for
providing a certification for the performance indicator if the personal employment information is validated.

26. The executable software product of claim 23 wherein the employment information storing instructions further include instructions for:
categorizing the employment information based at least one of a plurality of categories and a plurality of key indicators in the plurality of categories; and
storing the employment information based on the at least one of the plurality of categories and the plurality of key indicators.

27. The executable software product of claim 26 wherein the plurality of categories correspond to at least one of an industry and a profession.

28. The executable software product of claim 26 wherein the access providing instructions further include instruction for:
determining the performance indicator based on at least one of a portion of the plurality of categories, a portion of the plurality of key indicators, and a weight for each of the portion of the plurality of categories.

29. The executable software product of claim 28 wherein a position and an industry correspond to the employer and wherein the determining instructions further include instructions for:
providing a template to the employer, the template including the portion of the plurality of categories and the weight; and
receiving customization information from the employer, the customization information corresponding to at least one of the positions and the industry of the employer.

30. The executable software product of claim 23 wherein the access providing instructions further includes instructions for:
calculating the performance indicator as a normalized score.

31. The executable software product of claim 23 wherein employment information has an age and wherein the storing instructions further include instructions for:
determining a time factor for the employment information based on the age; and
wherein the access providing further includes
decaying a weight of the employment based on the time factor.

32. The executable software product of claim 23 wherein the program further includes instructions for:
receiving from the employer additional employment information related to at least additional one employee of the employer.

33. An executable software product stored on a computer-readable medium containing program instructions for evaluating an individual, the program instructions for:
providing to an employer a template for determining a performance indicator of performance based on employment information for the individual from at least one employer of the individual, the template including a plurality of categories and at least one key indicator corresponding to the plurality of categories, the employer being different from at least a portion of the at least one employer;
receiving customization information from the employer, the customization information including at least one of a portion of the plurality of categories, a portion of the at least one key indicator, and at least one weight, the at least one weight corresponding to the key indicator and the portion of the plurality of categories;
providing to the employer access to the employment information for determination of the performance indicator using the template and the customization information.

34. An executable software product stored on a computer-readable medium containing program instructions for allowing an employer to evaluate an individual, the program instructions for:
receiving a template for determining a performance indicator for the individual, the template including a plurality of categories and at least one key indicator corresponding to the plurality of categories;
customizing the template, the customizing including selection of at least one of a portion of the plurality of categories, a portion of the at least one key indicator, and at least one weight, the at least one weight corresponding to the key indicator and the portion of the plurality of categories;
calculating a performance indicator using the template, the customization information, and employment information for the individual, the employment information from at least one employer, the employer being different from at least a portion of the at least one employer of the individual.
